(19) United States
(12) Patent Application Publication
(10) Pub. No.: US 2021/0012449 A1
(43) Pub. Date: Jan. 14, 2021

(54) SYSTEM AND METHOD FOR PERFORMING LEGAL BACKGROUND CHECKS

(71) Applicant: A.M.S. INFORM PRIVATE LIMITED, Gautam Buddha Nagar (IN)

(72) Inventor: Sachin Aggarwal, Gautam Buddha Nagar (IN)

(21) Appl. No.: 16/923,430

(22) Filed: Jul. 8, 2020

(30) Foreign Application Priority Data
Jul. 8, 2019 (IN) 201911027271

(51) Int. Cl. G06Q 50/26; G06Q 10/10; G06Q 30/00; G06F 16/2457; G06F 16/25

(52) U.S. Cl. CPC G06Q 50/265; G06Q 10/10; G06F 16/252; G06F 16/24578; G06Q 30/0185

(57) ABSTRACT

There is disclosed a system for performing legal background checks of at least one individual including a server arrangement that is coupled to an e-court database, an act information database and a user interface for at least one client. The server arrangement receives bibliographic information of the at least one individual from the at least one client using the user interface, retrieves information from the e-court database using the received bibliographic information of the at least one individual, generates a match score for the retrieved information, identifies at least one relevant section of the act information database using the retrieved information, determines a type of legal matter related to the at least one individual and generates a legal background check report of the at least one individual.

### TECHNICAL FIELD

The present disclosure relates generally to background checks and verification of an individual; and more specifically, to systems for performing legal background checks of individuals. Furthermore, the present disclosure also relates to methods of performing legal background checks of individuals.

### BACKGROUND

There are a number of situations, where people interact with one another, and one of the interacting parties must make a decision as to whether or not to partner with or otherwise “engage” another party. The background screening is one of the most reliable indicators when it comes to determining the attitude and character of a person/party of interest. Legal background checks are also conducted for legitimate investigative purposes that are not regulated by the judiciary.

Typically, the legal background checks are used to ensure that the person of interest do not have any disqualifying event or any legal matter in any of his/her prior engagement. Traditionally, legal background checks are time consuming and require a lot of paperwork.

Typically, most relevant information about a particular party is learned through face-to-face interaction or indirect communication. Other important information, however, such as criminal background, financial instability, and invalidity of certain representations is generally not readily communicated by the person of interest.

Most private sector criminal history background checks re conducted by “consumer reporting agencies” (typically background screening companies) using the applicant's name and date of birth to search commercial databases and state and local government archives of criminal history records.

With most conventional legal background check services are expensive and time-consuming process. Moreover, there may be a reasonable explanation as to why the negative information exists, thereby exonerating the individual and allowing their status as a viable candidate to remain intact.

Other problems remain as well. For instance, despite all the advances associated with online information, the various public and private databases do not necessarily collaborate with each other. Thus, conventional systems are not instantaneous, in that multiple databases must be searched. In addition, the engaging party typically bears the cost for the screening process, putting an inordinate expense on that party, rather than distributing fair shares of that expense among each of the individuals. This expense to the engaging party is increased when a second background check is performed to prevent engaging on stale data.

Accordingly, when a background check is performed using the fraudulent name, no information regarding the actual individual applying for the position is uncovered. Therefore, any relevant information such as criminal convictions, etc. regarding the actual individual applying for the position remains unknown. A similar problem has recently received a lot of attention in the media with criminals using fraudulent identities to obtain individuals' personal information from data aggregators and subsequently stealing the individuals' identities.

Therefore, there exist a need of processes that allows client to obtain the background check report with all relevant details and explanations, in real-time manner.

### SUMMARY

An object of the present disclosure is to provide a system for performing legal background checks of individuals. Another object of the present disclosure is to provide a method of (for) performing legal background checks of individuals.

The present disclosure seeks to provide a solution to the existing problem of inaccurate, time consuming and expensive legal background checks. Moreover, the present disclosure seeks to provide a solution to the existing problem of determining accurate interpretation of the legal matters included in the background check reports. An aim of the present disclosure is to provide a solution that overcomes at least partially the problems encountered in prior art, and provides a system that enables a client to obtain an unbiased Legal background check report of an individual or a party in real-time manner.

In an aspect, embodiments of the present disclosure seeks to provide a system for performing legal background checks of at least one individual, wherein the system includes a server arrangement that is coupled to an e-court database, an act information database and a user interface for at least one client, characterized in that the server arrangement (in operations):
receives bibliographic information of the at least one individual from the at least one client using the user interface;
retrieves information from the e-court database using the received bibliographic information of the at least one individual;
generates a match score for the retrieved information;
identifies at least one relevant section of the act information database using the retrieved information;
determines a type of legal matters related to the at least one individual; and
generates a legal background check report of the at least one individual.

In another aspect, embodiments of the present disclosure seeks to provide a method of (for) performing legal background checks of at least one individual, wherein the method comprises:
receiving bibliographic information of at least one individual from at least one client using a user interface;
retrieving information from an e-court database by using the received bibliographic information of the at least one individual;
generating a match score for the retrieved information;
identifying at least one relevant section of an act information database using the retrieved information;
determining a type of legal matters related to the at least one individual; and
generating a legal background check report of the at least one individual.

Embodiments of the present disclosure substantially eliminate or at least partially address the aforementioned problems in the prior art, and enables the aforesaid system for performing legal background checks without involving any mediator or third person in a reliable, efficient and real time manner. Furthermore, the system provides transparency related to process of legal background check.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for performing legal background checks of at least one individual, in accordance with an embodiment of the present disclosure; and

FIG. 2 is a flow chart of method for performing legal background checks of at least one individual using the system of FIG. 1, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention relates to a system for performing legal background checks. The system may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove more convenient to construct more specialized apparatus to perform the required method steps. The required structure for a variety of these machines will appear from the description given.

In one aspect, the present disclosure seeks to provide a system for performing legal background checks of at least one individual, wherein the system includes a server arrangement that is coupled to an e-court database, an act information database and a user interface for at least one client, characterized in that the server arrangement (in operations):
receives bibliographic information of the at least one individual from the at least one client using the user interface;
retrieves information from the e-court database using the received bibliographic information of the at least one individual;
generates a match score for the retrieved information;
identifies at least one relevant section of the act information database using the retrieved information;
determines a type of legal matter related to the at least one individual; and
generates a legal background check report of the at least one individual.

In another aspect, the present disclosure seeks to provide a method of (for) performing legal background checks of at least one individual, wherein the method comprises:
receiving bibliographic information of at least one individual from at least one client using a user interface;
retrieving information from an e-court database by using the received bibliographic information of the at least one individual;
generating a match score for the retrieved information;
identifying at least one relevant section of an act information database using the retrieved information;
determining a type of legal matter related to the at least one individual; and
generating a legal background check report of the at least one individual.

The present disclosure provides the aforesaid system and the aforesaid method for performing legal background checks of at least one individual. Beneficially, the system provides a cost-effective and real-time solution for obtaining information of legal matters associated with an individual. Essentially, the system provides a platform to the client to obtain legal information associated with a person of interest in real-time and efficient manner.

It will be appreciated that the aforesaid system for performing legal background checks is not limited to a predefined number of the clients and the individuals. Moreover, the aforesaid system for performing legal background checks could be employed to perform a plurality of legal background checks simultaneously.

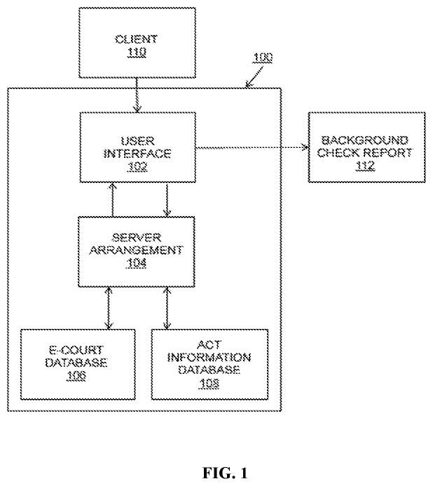

Now referring to FIG. 1, there is described is a block diagram of a system 100 for performing legal background checks of at least one individual, in accordance with an embodiment of the present disclosure. As shown, the system 100 includes a server arrangement 104, an e-court database 106, an act information database 108 and a user interface 102. The server arrangement 104 is communicably coupled to the e-court database 106, the act information database 108 and the user interface 102 for at least one client 110. The server arrangement 104, when in operation, receives bibliographic information of at least one individual from the at least one client 110 using the user interface 102, retrieves information from the e-court database 106 using the received bibliographic information of the at least one individual, generates a match score for the retrieved information, identifies at least one relevant section of the act information database 108 using the retrieved information, determines a type of legal matter related to the at least one individual and generates a legal background check report 112 of the at least one individual.

Throughout the present disclosure the term “server arrangement” relates to an arrangement of at least one server that, when operated, performs the aforementioned steps and generates the legal background check report 112. The term “server arrangement” generally refers to an application, program, process or device in a client-server relationship that responds to requests for information or services by another application, program, process or device (a client) on a communication network. The term “server arrangement” also encompasses software that makes the act of performing the legal background checks possible. The term “client” generally refers to an application, program, process or device in a client-server relationship that requests information or services from another application, program, process or device (the server) on the communication network. Importantly, the terms “client” and “server” are relative since an application may be a client to one application but a server to another application. The term “client” also encompasses software that makes the connection between a requesting application, program, process or device and a server possible, such as an FTP client.

Furthermore, the server arrangement 104 is communicably coupled to the e-court database 106, the act information database 108 and the user interface 102 for at least one client 110 using a communication network. It will be appreciated that the communication network can be an individual network, or a collection of individual networks that are interconnected with each other to function as a single large network. The communication network may be wired, wireless, or a combination thereof. Examples of the individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, radio networks, telecommunication networks, and Worldwide Interoperability for Microwave Access (WiMAX) networks.

Throughout the present disclosure the term “processing unit” refers to a processor within a computer that carries out instructions of a computer program.

Throughout the present disclosure the term “client device” may include but not limited thereto a mobile communication device, laptop, computer and tablet.

Throughout the present disclosure the term “user interface” refers to a means by which a user and a computer system interact. Throughout the present disclosure, the server arrangement is communicably coupled to a processing unit of a client device, wherein the client requests services though the user interface of the client device.

The server arrangement 104, when in operation, receives the bibliographic information of the at least one individual from the at least one client 110 using the user interface 102. Further, the server arrangement 104, when in operation, retrieves information from the e-court database using the received bibliographic information of the at least one individual and generates a match score for the retrieved information. Furthermore, the server arrangement 104, when in operation, identifies at least one relevant section of the act information database using the retrieved information, determines a type of legal matter related to the at least one individual and generates the legal background check report 112 of the at least one individual.

In an embodiment, the bibliographic information may include the name and address of the at least one individual. Additionally, the bibliographic information may further include date of birth, father's name, mother's name, spouse's name and so forth.

In another embodiment, the e-court database 106 may include a plurality of legal records including at least one of a police verification data; a criminal court data; a police clearance certificate data; and an online criminal verification data.

The term “police verification data” refers to legal records associated with different parties that are secured with local police station of respective jurisdiction.

The term “criminal court data” refers to legal records related to different individuals that are secured with District and High courts.

The term “Police clearance certificate data” refers to legal records related to different individuals that are secured with Police Commissioner Office/Superintendent of Police.

The term “online criminal verification data” refers to legal records related to different individuals that are secured with online database of District Courts and Proprietary Databases.

In an embodiment, the legal background check report 112 may include the bibliographic information of the at least one individual, the identified at least one relevant section, the match score and the determined type of legal matter related to the at least one individual. Optionally, the type of legal matter related to the at least one individual may include at least one of a civil and a criminal matter.

Throughout the present disclosure the term “legal matter” refers to an issue between two or more parties that requires legal consideration. Further, the term “civil matter” refers to a matter that involves a legal dispute between two or more parties. The civil action begins when a party to a dispute files a complaint and pays a filing fee required by statute. Furthermore, the term “criminal matter” refers to a matter that begins when a person suspected of a crime is indicted by a grand jury or otherwise charged with the offense by a government official called a prosecutor or district attorney.

In an embodiment, the match score may be generated based on a level of matching of the received bibliographic information with information present in the plurality of legal records of the e-court database.

In an exemplary embodiment, in an event of exact match of the name and the address of the at least on individual in the legal records of the at least one of the police verification data, the criminal court data, the police clearance certificate data and the online criminal verification data; the match score is 100.

In other exemplary embodiments, in the event of partial name match and full address match the match score may range between 85-99. Similarly, in the event of full name match and partial address match the match score may range between 85-99.

In yet another exemplary embodiment, in the event of partial name match and partial address match the match score may range between 75-84.

In an embodiment, the server arrangement 104, when in operation, may create a plurality of search stings by creating phonetic variant of the name of the at least one individual.

Specifically, creating phonetic variant of the name of the at least one individual is advantageous in terms of providing additional searches in the e-court data base, thus retrieving additional legal records related to the at least one individual.

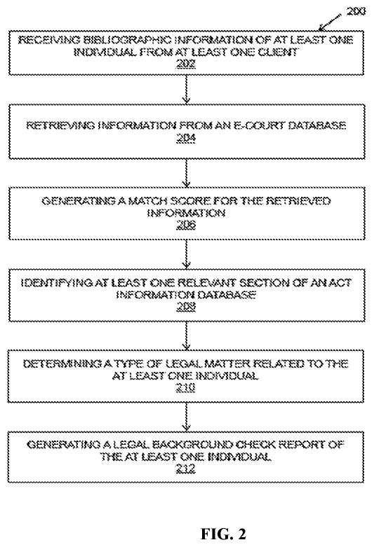

Now referring to FIG. 2, there is shown a flow chart of method 200 for performing legal background checks of at least one individual using the system (such as the system 100 of FIG.1), in accordance with an embodiment of the present disclosure. As shown, the method 200 initiates at a step 202. In the step 202, the method 200 includes receiving bibliographic information of at least one individual from at least one client (such as the client 110 of FIG. 1) using a user interface (such as the user interface 102 of FIG. 1). In a second step 204, the method 200 includes retrieving information from an e-court database (such as the e-court database 106 of FIG. 1) by using the received bibliographic information of the at least one individual. In a third step 206, the method 200 includes generating a match score for the retrieved information. In a fourth step 208, the method 200 includes identifying at least one relevant section of an act information database (such as the act information database 108 of FIG. 1) using the retrieved information. In a fifth step 210, the method 200 includes determining a type of legal matter related to the at least one individual. In a sixth step 212, the method 200 includes generating a legal background check report (such as the legal background check report 112 of FIG. 1) of the at least one individual.

The steps 202 to 212 are only illustrative and other alternatives can also be provided where one or more steps are added, one or more steps are removed, or one or more steps are provided in a different sequence without departing from the scope of the claims herein.

In an embodiment, the method 200 may further include creating a plurality of search stings by creating phonetic variant of the name of the at least one individual. Specifically, creating phonetic variant of the name of the at least one individual is advantageous in terms of providing additional searches in the e-court data base, thus retrieving additional legal records related to the at least one individual.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A system for performing legal background checks of at least one individual, wherein the system includes a server arrangement that is coupled to an e-court database, an act information database and a user interface for at least one client, characterized in that the server arrangement (in operations):
receives bibliographic information of the at least one individual from the at least one client using the user interface;
retrieves information from the e-court database using the received bibliographic information of the at least one individual;
generates a match score for the retrieved information;
identifies at least one relevant section of the act information database using the retrieved information;
determines a type of legal matter related to the at least one individual; and
generates a legal background check report of the at least one individual.

2. A system of claim 1, wherein the bibliographic information includes a name and address of the at least one individual.

3. A system of claim 1, wherein the e-court database includes a plurality of legal records related to at least one of:
a police verification data;
a criminal court data;
a police clearance certificate data; and an online criminal verification data.

4. A system of claim 1, wherein the legal background check report includes the bibliographic information of the at least one individual, the identified at least one relevant section, the match score and the determined type of legal matter related to the at least one individual.

5. A system of claim 1, wherein the match score is generated based on a level of matching of the received bibliographic information with information present in the plurality of legal records of the e-court database.

6. A system of claim 1, wherein the determined legal matter includes at least one of a civil and a criminal matter.

7. A method of (for) performing legal background checks of at least one individual, wherein the method comprises:
receiving bibliographic information of at least one individual from at least one client using a user interface;
retrieving information from an e-court database by using the received bibliographic information of the at least one individual;
generating a match score for the retrieved information;
identifying at least one relevant section of an act information database using the retrieved information;
determining a type of legal matter related to the at least one individual; and
generating a legal background check report of the at least one individual.

8. A method of claim 7, wherein the bibliographic information includes a name and address of the at least one individual.

9. A method of claim 7, wherein the e-court database includes a plurality of legal records related to at least one of:
a police verification data;
a criminal court data;
a police clearance certificate data; and an online criminal verification data.

10. A method of claim 7, wherein the legal background check report includes the bibliographic information of the at least one individual, the identified at least one relevant section, the match score and the determined type of legal matter related to the at least one individual.

11. A method of claim 7, wherein the method further includes matching of the received bibliographic information with information present in the plurality of legal records of the e-court database, for generating the match score.

12. A method of claim 7, wherein the determined legal matter includes at least one of a civil and a criminal matter.
